(19) United States
(12) Patent Application Publication
(10) Pub. No.: US 2026/0233858 A1
(43) Pub. Date: Aug. 13, 2026

(54) DEVICE FOR OPENING AND COLLECTING HOSES USED TO TRANSPORT CONDITIONED AIR IN AIRPORTS

(71) Applicant: GOKSER ARGE SAVUNMA HAVACILIK ANONIM SIRKETI, Ankara (TR)

(72) Inventor: Serhat UNAL, Ankara (TR)

(73) Assignee: GOKSER ARGE SAVUNMA HAVACILIK ANONIM SIRKETI, Ankara (TR)

(21) Appl. No.: 19/164,217

(22) PCT Filed: Mar. 12, 2024
(86) PCT No.: PCT/TR2024/050248

§ 371 Date: Sep. 11, 2025

(30) Foreign Application Priority Data
Dec. 26, 2023 (TR) 2023/018532

(51) Int. Cl. B64F 1/36

(52) U.S. Cl. CPC B64F 1/362

(57) ABSTRACT

The subject of the invention is the use of flexible aviation hoses (11) used to transport heated, cooled, conditioned, conditioned and purified air to all types of aircraft in all types of aircraft service areas, under or next to the passenger bridge on the apron, in a practical and accurate manner within the framework of the fast working tempo of the service areas. it is a device that will allow the flexible aviation hoses to be opened and collected by a single employee. The benefits of fast, practical and accurate collection of the flexible aviation hoses used by one employee are to increase occupational safety in the service area, to extend the life of the flexible aviation hoses used. it increases the efficiency of the systems used to provide heated, cooled, conditioned, air-conditioned and/or purified air to aircraft and shortening the service period of aircraft by accelerating activities.

### TECHNICAL FIELD

The invention relates to a device that enables the collection and opening of flexible aviation hoses used to transport heated, cooled, conditioned, and purified air provided for passenger aircraft and other air transportation vehicles in airports, passenger bridges, hangars, runways and similar environments.

### KNOWN STATUS OF THE TECHNIQUE

All aircrafts need various ground support equipment. Some of this equipment are used to air-condition the cabin sections of aircraft using air that is heated, cooled, conditioned as required and/or free of pathogens, considering the sensitivity required by these aircrafts and equipment. Flexible aviation hoses are used to provide the connection between the air outlets located at fixed points on the devices located in different places in the environment where the aircraft is located and serviced, and the air inlets whose positions vary between models and to carry the air that has gone through the mentioned processes to the aircraft. There are many reasons why flexible aviation hoses, which can reach lengths of 30 or 40 meters when fully opened, are collected in the service area when they are not in use or during use and are opened only to the required lengths. Among these reasons, such as occupational safety, efficiency of air conditioning systems and lifespan of hoses, the necessary care cannot be taken in collecting these hoses in practice, and there is no solution or device suitable for the fast pace in service areas.
in the current state of technology, there are problems such as the use, opening, collection and storage of these flexible aviation hoses, which act as air ducts, occupational safety around the hoses, system efficiency of which the hoses are apart, and the lifespan of the hoses. Because service personnel cannot find the time to manually collect or open the hoses in the fast pace required in the service area, or because it takes too long for these systems to perform the collection and opening operations in cases where there is a system installed for opening and collecting hoses, the hoses lie on the ground in the work area idle around the aircraft. Leaving hoses on the ground is a violation of occupational safety in an environment where many people work together and quickly. in addition, leaving, moving, and dragging the hoses on hard concrete or asphalt-like surfaces causes wear and damage to the spiral structures made of metal or plastic around the hose, which maintain the shape of the hose and provide efficient air transport. Although there are wheeled carts produced to carry hoses to prevent these abrasions, these carts do not provide an advantage and are therefore not actively used. Another problem in the state of the act is that an operator using an existing hose retriever system may pull the hose due to the slowness of the process and thus inappropriately apply forces that will damage the hose to open the hose faster. Hoses are not only damaged by being pulled in the direction of extension; applying more pressure on the hose spirals than necessary can also damage the hose. in other words, excessive forces applied to the hose to grasp the hose within the hose retriever devices within the scope of the state of the act also seriously shorten its lifespan and cause wear on the hose.
in some known application techniques, the hose is collected manually by an employee, and is manually placed in a crate or similar storage container where the hose will be stored. Performing this process manually by an employee may cause errors in collecting the hose properly, and even if no errors are made, it takes a long time.

Extending the duration of operations in the service area disrupts air traffic and poses a risk to occupational safety.
in some hose collection and opening systems within current technology, the mechanisms used for this purpose mostly work by holding on to the hose and pulling the hose into the device with a series of claw or hook-like structures that open and close sequentially. This solution causes hose opening and collection operations to take too long and hose movements to be inconsistent.

Correctly opening and collecting air-carrying flexible aviation hoses increases occupational safety and the lifespan of the hoses, as well as the efficiency of the ventilation and air conditioning systems of which the hoses are apart. Although the air outlet points of systems in airports, hangars, runways, or similar areas are fixed, the air inlet points of aircraft vary between each model and type. Therefore, fixed length air ducts cannot be used to solve this connection between the system and the aircraft, flexible aviation hoses are used instead. in cases where the aircraft's air intake is far away, the hose opens completely in a straight line and this does not have a negative impact on the system. in cases where the air inlet is close to the system and the hose is open, air can only reach the aircraft after passing the hose from end to end. The extra distance the air travels inevitably negatively affects the performance of the system. Hose must bend, twist, and turn to connect to inlet points closer to the system. This shape of the hose is also harmful to the hose, and deformities destroy the air flow. As a result, the hose length must be adjusted to the aircraft and the excess hose must be compressed and preserved without damage.

Another situation that causes damage to flexible hoses is that the spiral-shaped structures surrounding the hoses, under normal conditions, want to rotate during the compression of the hose, but in the current systems, this rotation movement is prevented because both ends are fixed. Failure of this rotational movement during compression causes the spiral structure and consequently the diameter of the hose to increase, meaning that the fabric material in the structure of the hose is kept under stress throughout the storage period. This situation negatively affects the service life of the hose.

### How the Invention is Applied to Industry

The way the device subject to the invention is applied to industry is to place it in aircraft in situations and environments where heated, cooled, conditioned, conditioned and purified air must be provided by ground support equipment, and to open-collect the flexible aviation (11) hoses used to connect the support equipment and aircraft before use. If the device subject to the invention is applied to industry, occupational safety in aircraft service areas will increase, the lifespan of flexible aviation hoses used in the service area will be extended, the efficiency of the systems used to provide heated, cooled, conditioned, air-conditioned and/or purified air to aircraft will increase, and the working process in the service area will increase. it is anticipated and targeted that the working process in the service area will also be positively affected.

The device that is the subject of the invention is located between the support equipment and the aircraft in the service area. in some applications, it is mounted under the passenger bridge. The air inlet of the device is connected to a permanently positioned ground support device. The flexible aviation hose (11) to be connected to the aircraft is opened using the control (14) on the hose adapter (12) suitable for the entrance of the aircraft. When the opened flexible aviation hose (11) reaches the ap propriate length, the opening process is stopped, and the flexible hose (11) is connected to the aircraft. When the aircraft's service process is completed, the hose is separated from the aircraft and the collection process starts by using the same control (14). When the collection of the hose is completed, the collection process can stop automatically, or the hose can be left at another length.

Due to the device that is the subject of the invention, this process can be carried out by a single operator. The fact that the device that is the subject of the invention operates at least twice as fast as existing systems will make collecting the hoses in the service area more practical and will prevent the hoses from being left or piled up on the floor of the service area in ways that would distort their form.

### Detailed Description of the Invention

The purpose of the invention is to enable flexible aviation hoses (11), which are used to transport heated, cooled, conditioned, conditioned and purified air to all types of aircraft in all types of aircraft service areas, to be opened and collected practically and accurately by a single employee within the framework of the fast working tempo of the service areas. The benefits of collecting the used flexible aviation hoses (11) quickly, practically and accurately by a single employee are to increase occupational safety in the service area, to extend the life of the used flexible aviation hoses (11), to provide heated, cooled, conditioned, air-conditioned and/or purified air vehicles, to increase the efficiency of the systems used to provide air and to shorten the service time of aircraft by accelerating activities.

### BRIEF DESCRIPTION OF DRAWINGS

FIG. 1 shows the general isometric view of the device that is the subject of the invention.

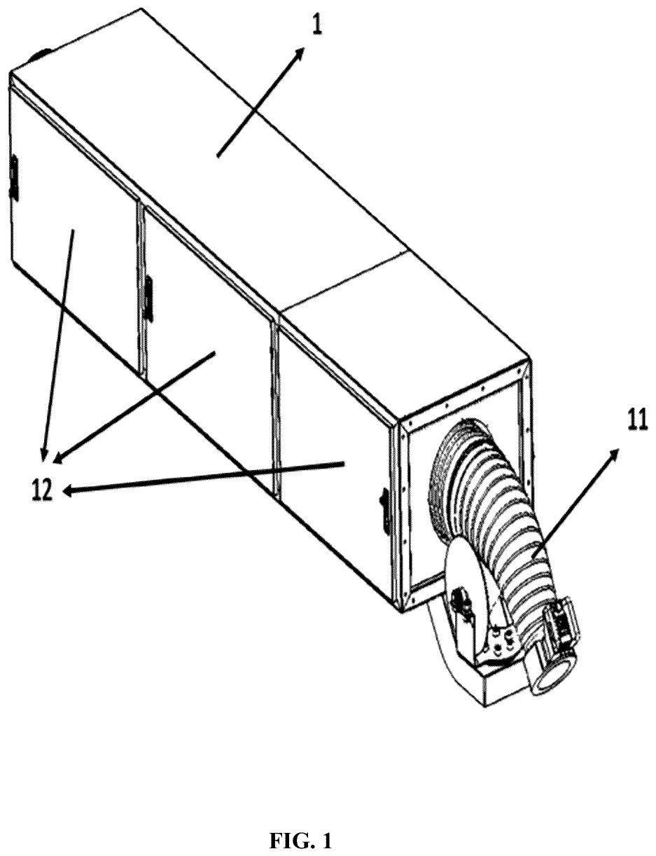

FIG. 2 shows a detailed upper section of the device that is the subject of the invention.

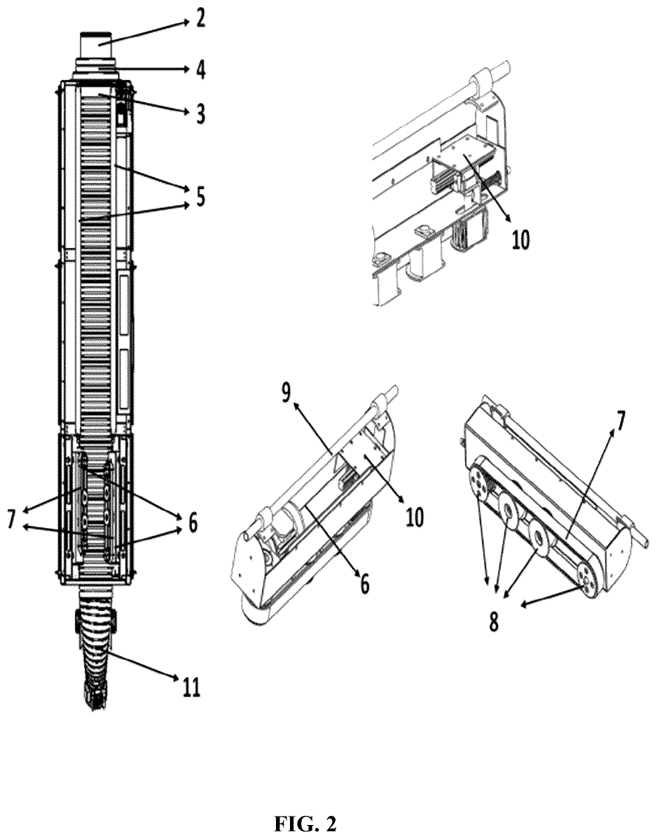

FIG. 3 shows the air inlet end and tambour mechanism of the device that is the subject of the invention.

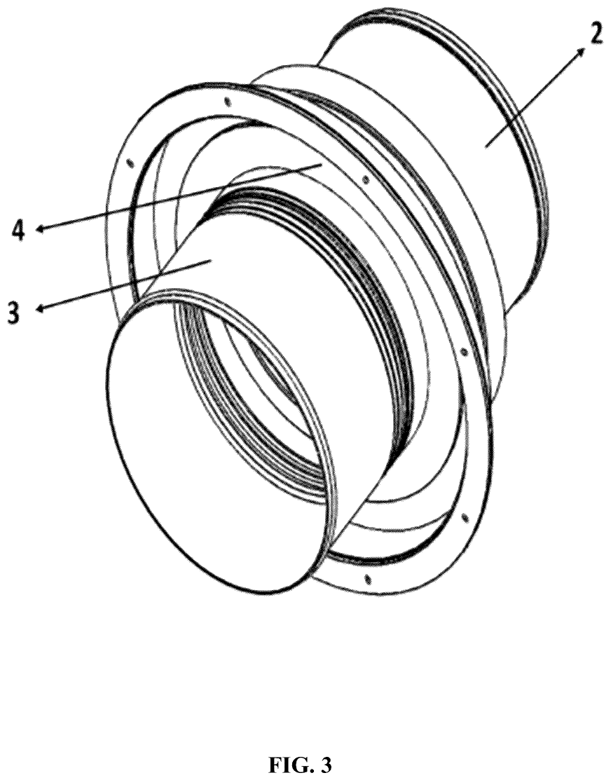

FIG. 4 shows the sensor and motion modules of the device that is the subject of the invention,

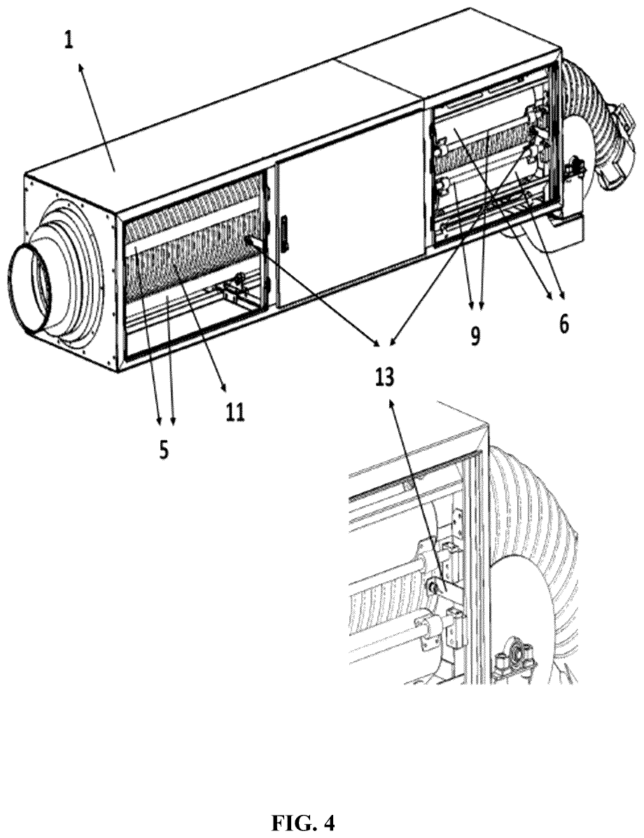

FIG. 5 shows the control panel of the device subject to the invention and the detail of the aircraft connection socket.

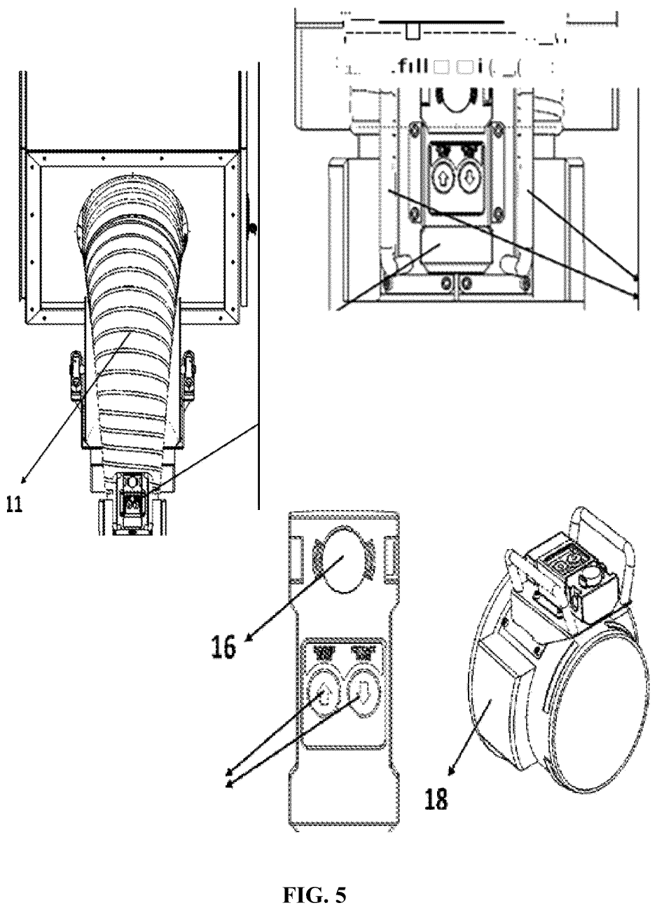

FIG. 6 shows the detail of the motion modules of the device that is the subject of the invention.

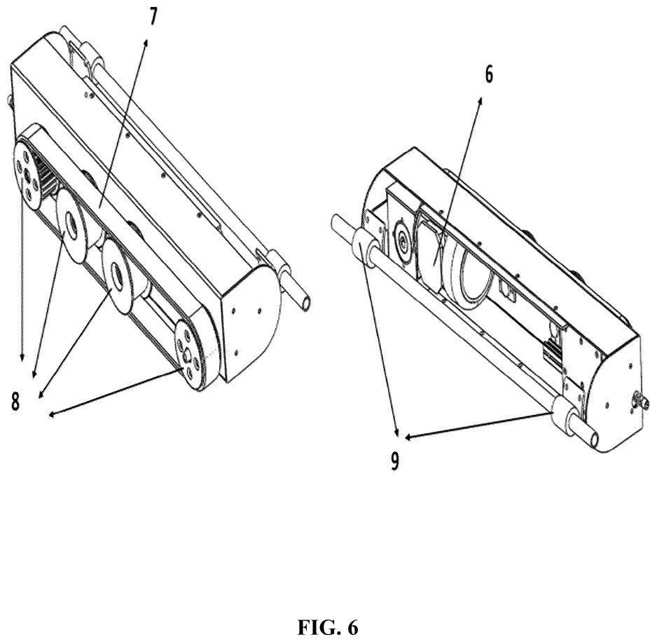

FIG. 7 shows the machine covers of the device that is the subject of the invention.

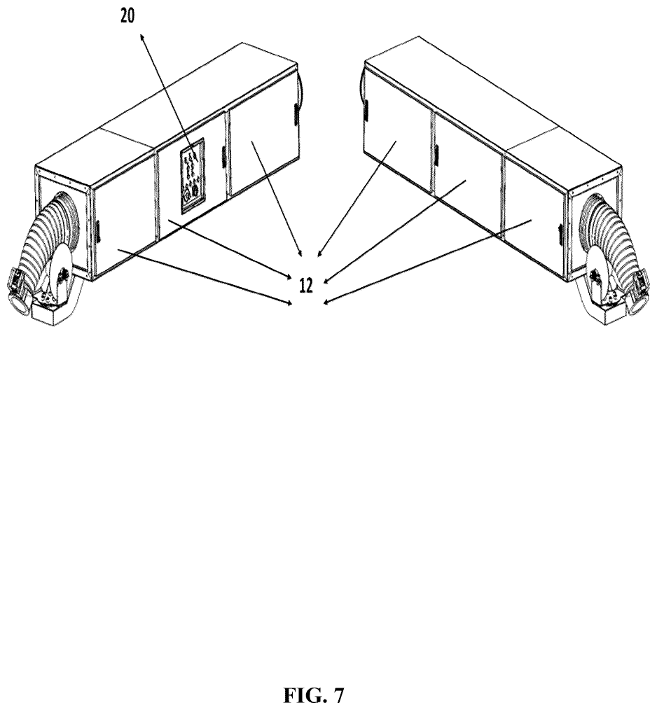

FIG. 8 shows the hose support cylinder located in front of the device.

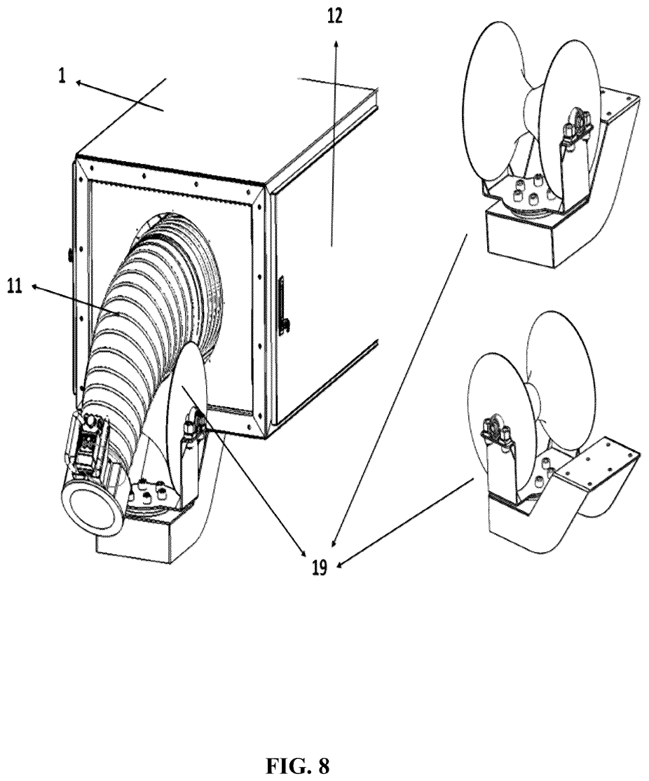

FIG. 9 shows the details of the System electrical panel.

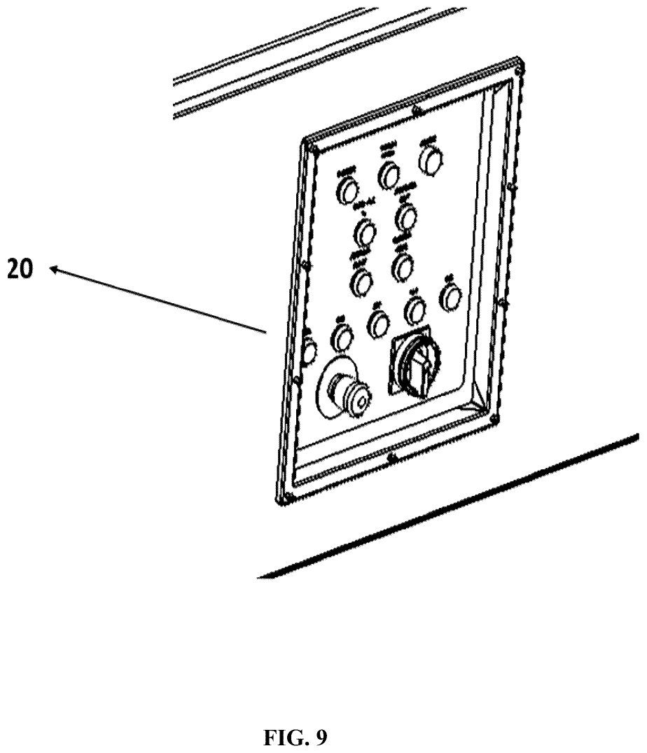

### EXPLANATION OF REFERENCES IN THE FIGURE

1—Machine chassis
2—Air inlet/Fixed Tambour
3—Movable Tambour
4—Sealing mechanism/disk
5—Bearing storage guides
6-380VAC motors
7—Composite pallets
8—Composite Track gears
9—Hinged motion module connection
10—Composite Pallet tensioner
11—Flexible aviation hose
12—Machine covers
13—Optical sensors
14—Remote control
15—Hose opening/collection buttons
16—Emergency stop button
17—Handles
18—Connection adapter suitable for the aircraft
19—Hose Support Cylinder
20—System Electrical Panel

### DESCRIPTION OF EMBODIMENTS

The Device for Opening and Collecting Hoses Used to Transport Conditioned Air in Airports consists of;
1—Machine chassis
2—Air inlet/Fixed Tambour
3—Movable Tambour
4—Sealing mechanism/disk
5—Bearing storage guides
6—380VAC motors
7—Composite pallets
8—Composite Track gears
9—Hinged motion module connection
10—Composite Pallet tensioner
11—Flexible aviation hose
12—Machine covers
13—Optical sensors
14—Remote control
15—Hose opening/collection buttons
16—Emergency stop button
17—Handles
18—Connection adapter suitable for the aircraft
19—Hose Support Cylinder
20—System Electrical Panel

The subject of the invention relates to a device consisting of a storage section and hose opening/collecting sections, which is used to open or collect flexible aviation hoses in service areas without damaging these hoses or employees.

The storage section is the part that houses the air inlet mechanism and bearing storage guides (5), where the hose is stored when completely collected. The air inlet of the device consists of a fixed Tambour (2), a movable Tambour (3) and a sealing disc (4). The fixed drum (2) provides the connection between the ground support equipment and the device of the invention. The moving tambour (3) is connected to the 380 V 50 Hz motor-reducer duo to provide and support the rotational movement of the hose. Since the rotation speed of the moving drum when the hose is fully open is different from the rotation speed required when it is close to full closure, the moving drum needs to rotate at a variable rate. This has been solved with a new mechanical solution by mounting the belt system with a limited slip to meet the variable speed need while transferring the movement from the motor-reducer duo with the belt-pulley system. in this way, the constant torque and speed coming from the motor-reducer duo ensure that the moving drum rotates as fast as needed with the limited slip belt system and the rotation speed can be increased or decreased as needed. This feature is not available in similar devices. Power transfer between the motor (6) and the drum (3) is provided by a belt.

The disc (4), which is located between the fixed drum (2) and the movable drum (3) and whose function is to provide sealing, clamps the two drums together and provides sealing between the drums when air flow occurs within the device and at these connection points. in fact, the part, which works like a clutch plate, acts as a coupler in the system. When the air flow is interrupted, it returns to its previous position, allowing the moving drum (3) to return to free movement.

Bearing storage guides (5) are four tubular structures that extend parallel to the hose throughout the storage section, are supported by the bearings at both ends, and can rotate freely around this axis. The ball bearing storage guides (5) can rotate with the hose. in this way, while opening and collecting the hose, no friction or tension occurs inside the device that could damage the hose. The placement of the bearing storage guides (5) is such that there is one at opposite comers around the hose.

The rotation of the hose during opening and collection allows the spiral structure sur rounding the flexible aviation hoses (11) to be opened or collected in an orderly manner.
in addition to the hose taking up less space in the storage compartment, the ability to collect the hose in this way helps the spiral structure maintain its form, reduces the pressure on the hose walls, prevents the hose from tearing and prolongs its life.

Each of the motion modules (9) on the device that is the subject of the invention, which provides movement transfer during the opening and collection of the hose, is identical and consists of a 380 V 50 Hz motor (6), a composite pallet (7), pallet gears instead of a 24V DC motor with reducer used in similar models, pallet gears (8) and a tensioner (10) mechanism that ensures the correct amount of tension or loosening of the composite pallet.

Based on the use of a 380V AC motor, the torque value has been kept constant and a standard and ubiquitous component was used. This has made the maintenance and repair of the motion module easier and parts available compared to similar models.

Each of the motion modules (9) on the device subject to the invention, which provide movement transfer during the opening and collecting of the hose, are identical and consist ofa 380 VAC motor with reducer (6), a composite pallet (7), pallet gears (8) and a tensioner (10) mechanism that ensures the correct amount of tension or loosening of the composite pallet. All these components were enclosed in an aluminum cell with a unique shape, thus protecting the components against water or dust, and creating a “motion module”, achieving a holistic structure and appearance.
in the device of the invention, composite pallets (7) are used to provide movement transfer between the engines and the flexible aviation hose (11). Composite pallets (7) consist of two layers with a unique feature. The part in contact with the hose spiral has an anti-slip structure. The drive side is made of geared and wear-resistant material, and the pallet is created by combining these two materials. Unlike the spiral rollers used in existing systems, it ensures that the force applied to the hose is transferred more regularly and accurately, and thus it can work faster without allowing the hose to be damaged because of the forces applied to open or collect the hose. The operating speed of the system is 2 times higher than existing systems in order to keep up with the work tempo in the service area and to prevent situations such as pulling the hoses manually by operators with excessive force.

The composite pallets (7) used are approximately 80 cm long, and along this length they apply force and transfer movement by only contacting the spiral structure on the outside of the hose, that is, without contacting the polyester fabric part of the hose. The side of the composite pallet that contacts the spiral structure is a nan-slip material.

The flexibility of the clutch system and the mounting of the movement modules (9) on the machine chassis (1) via hinge-like joints is a safety measure against scenarios such as the hose getting stuck somewhere when it is opened or collected quickly or the operator losing control. in such cases, the composite pallets (7) slide on the hose surface and the device stops transmitting force to the hose. Due to the hinge-like connection, the movement modules (9) can rotate towards the hose and thus continue to transmit the movement by perfectly adapting to instantaneous diameter changes that may occur in the hose. in addition, it has become easier to intervene in the modules; the module can be replaced with a spare one quickly and easily by a single person by simply turning it outwards.

There is a pallet tensioner (10) in each movement module (9). Due to this mechanism, the tension of the composite pallets (7) can be adjusted via a single bolt. This also makes it possible to remove, install and replace the pallet (7) from the system using only this bolt. Asa result, the interventions and maintenance process performed on the device that is the subject of the invention requires an extremely short time and little labour.

The pallet gear furthest from the engine, which is in the motion module and serves to support the composite pallet movement, can move linearly on the axis parallel to the pallet direction. As a result of this linear movement, the distance or proximity of this gear to other gears and the engine can be changed. Increasing the distance of the gear from the engine causes the tension of the composite pallet to increase, and decreasing the distance causes the tension of the composite pallet to decrease. A bolt is used to ensure this movement and maintain the tension setting. Turning this bolt directly affects the track tension and ensures that it remains at the point where it was left.

Optical sensors (13) placed at different points of the device control the movement limits determined to protect the hose and device during hose opening and collection. When any of the Optical Sensors (13) are triggered within these limits, motion transmission to the hose is interrupted and the hose is prevented from being exposed to more force than necessary or the device is prevented from being damaged.

A support cylinder (19) placed at the outlet end of the device and having a profile suitable for the outer diameters of the hoses supports and directs the hose during the opening and collecting process. Reducing friction at this point of the system in this way both increases the performance of the system and extends the life of the hose.

The negative features of 24VDC motors used in similar systems, such as improper torque distribution and difficulty in finding the motor as a spare part, have been eliminated by using a 380 V 50 Hz motor in the device subject to the invention. in this way, torque distribution has been much improved compared to systems using 24VDC, and a standard and ubiquitous motor has been used.

The control of the device subject to the invention can be in more than one way to provide convenience to the operator during use. The device can be controlled via a remote control (14), a control box mounted on the fitting at the end of the hose, or a panel on the device. Being able to control it in more than one way allows the device to be used with different task distributions or even by a single person.

Control of the device subject to the invention can be provided by an ergonomically positioned remote control (14). Since the control panel (14) that controls the hose collection device of the invention is located on the hose nozzle, the operator can reach the required control opening/collecting (15) buttons and control the system using only his thumbs while carrying it by holding the carrying handles (17) on the hose nozzle. Again, due to an emergency response button (16) located on this control panel (14), any disruptions that may occur during the hose opening and collection operations are prevented immediately, without harming anyone, in a way that ensures work and workplace safety.

The main body of the device is in the shape of a rectangular prism. The dimensions vary in proportion to the hose capacity that the system must accommodate. Comers are strengthened using U-Profiles. in the device that is the subject of the invention, AISI 304 type stainless steel is used as structural material and aluminum for internal parts. The parts used are painted with electrostatic paint to make them resistant to weather conditions.

There are machine covers (12) that allow access from both sides of the device that is the subject of the invention and serve to protect the machine chassis and other elements of the device from external environmental conditions. The placement of these covers (12) provides access to the inside of the device from all angles and allows service from any point without the need to change the location of the device.

The connection points on the top of the device that is the subject of the invention allow the device to be connected under the bridge and positioned close to air conditioning devices. This frees up more space to work in the service area.

Making the automatic hose collection and opening process more rapid can prevent a busy employee from piling the hose aside or in a closed environment, because collecting the hose during this process becomes a more practical, effective, and faster solution for the employee.

The device that is the subject of the invention has solved a problem in the field of security, a feature that is not available in similar devices. The electronic unit of the device is in electronic communication with the passenger bridge to which its mechanical connection is made, and it has an electronic communication that prevents the hose machine from operating in cases where the passenger bridge moves. This electronic communication system similarly prevents the passenger bridge from being moved by the operator if the hose in the hose collection machine is not completely collected, thus preventing the hose from being damaged by the passenger bridge movement system.

As an innovation, the device subject to the invention is equipped with a unique feature in order to prevent the user-operator from exerting too much effort, especially when opening the hose. Accordingly, when the operator presses the on button of the device and starts to remove the hose, the electronic communication part of the hose collection machine sends a signal to the blower part of the external air conditioning device, causing the air conditioning blower to rotate at low speed or half speed, and the pressure in the hose brought by the hose blower operation coming out of the hose collection machine. Due to its increase, it allows the hose to move forward, thus the operator moves the hose in a more directional manner. This minimizes the physical fatigue of the working operator. This feature is not available in any similar products.

What is claimed is:

1.-27. (canceled)

28. A device for opening and collecting a flexible aviation hose having a tubular wall and an external spiral structure, the device comprising:
a machine chassis defining a hose path along a longitudinal axis;
a plurality of motion modules arranged around the hose axis, each motion module comprising:
an electric motor with a reducer;
pallet gears driven by the electric motor; and
a composite pallet extending along the hose and operatively engaged with pallet gears of the motion module such that movement of the gears drives the pallet, wherein the composite pallet comprises:
a hose-contacting side configured to engage the external spiral structure of the hose without contacting the tubular wall, the hose-contacting side comprising an anti-slip gripping surface; and
a drive side engaged by the pallet gears, the drive side comprising a wear-resistant surface;
a hinged motion module connections mounting the motion modules to the machine chassis, the hinged motion module connection biasing the composite pallets toward the hose while permitting radial compliance of each motion module to:
accommodate changes in hose diameter; and
interrupt motion transfer in the event of hose obstruction; and
bearing storage guides disposed about the hose axis within a storage section of the machine chassis, the bearing storage guides comprising rotatable bearing pipes configured to permit the hose to rotate about the hose axis during collection and extension, thereby reducing stress on the hose, wherein coordinated operation of the motion modules advances or retracts the hose by engagement of the composite pallets with the spiral structure.

29. The device of claim 28, wherein the plurality of motion modules comprises four motion modules arranged symmetrically about the hose axis.

30. The device of claim 28, wherein the composite pallet comprises a double-layer composite structure, the hose-contacting side formed of an anti-slip elastomeric material and the drive side formed of a toothed, wear-resistant material.

31. The device of claim 28, wherein each motion module further comprises a pallet tensioner configured to adjust tension of the composite pallet.

32. The device of claim 31, wherein the pallet tensioner comprises a pallet gear movable linearly relative to the motor, the position of the pallet gear being adjustable by a bolt to increase or decrease pallet tension.

33. The device of claim 31, wherein the pallet tensioner allows installation, removal, or replacement of the composite pallet using only a single bolt.

34. The device of claim 28, wherein each motion module is mounted to the machine chassis by a hinged motion module connection that permits the motion module to be swung outward for removal and servicing without disassembly of the chassis.

35. The device of claim 34, wherein the hinged connection allows the motion modules to adapt to variations in hose diameter of at least about 3 cm.

36. The device of claim 28, wherein each motion module is enclosed in a sealed housing configured to protect the motor, pallet gears, and composite pallet from water and dust.

37. The device of claim 28, wherein the bearing storage guides comprise four bearing pipes disposed at opposite corners around the hose.

38. The device of claim 37, wherein the bearing storage guides reduce radial forces on the hose, allowing the spiral structure to follow its natural movement and prolonging hose life.

39. The device of claim 28, further comprising a hose support cylinder located at an outlet of the chassis, the hose support cylinder being rotatable to support and direct the hose during collection and extension.

40. The device of claim 28, further comprising a movable drum at an air inlet of the chassis, the movable drum being rotatably driven to support hose movement.

41. The device of claim 40, further comprising a fixed drum adjacent the movable drum and a sealing mechanism between the drums, the sealing mechanism configured to couple the drums together during air flow to provide sealing.

42. The device of claim 40, wherein the movable drum is driven through a belt-pulley transmission with limited slip, permitting variable drum speed relative to the motor.

43. The device of claim 28, further comprising optical sensors positioned to detect hose length limits during collection and extension, the sensors being configured to stop hose motion when a limit is reached.

44. The device of claim 28, further comprising an emergency stop button configured to immediately halt hose motion.

45. The device of claim 28, further comprising a remote control mounted on an aircraft connection adapter at the end of the hose, the remote control including buttons for controlling hose extension and collection.

46. The device of claim 45, further comprising handles on the adapter, wherein the buttons are positioned to be actuated by a thumb of an operator while gripping the handles.

47. The device of claim 28, further comprising an electronic communication module configured to send a signal to a passenger bridge system to block movement of the bridge while the hose is deployed.

48. The device of claim 47, wherein the electronic communication module is further configured to prevent hose operation when the passenger bridge is in motion.

49. The device of claim 28, wherein the electronic communication module is configured to send a signal to an external air conditioning unit to activate a blower during hose extension, thereby assisting hose opening by internal air pressure.
